(19) United States
(12) Patent Application Publication
(10) Pub. No.: US 2009/0222907 A1
(43) Pub. Date: Sep. 3, 2009

(54) DATA AND A COMPUTER SYSTEM PROTECTING METHOD AND DEVICE

(76) Inventor: Patrice Guichard, Cachan (FR)

Correspondence Address: Young & Thompson, 745 S. 23rd Street., Second Floor, Arlington, VA, 22202, US

(21) Appl. No.: 11/917,583

(22) PCT Filed: Jun. 14, 2006
(86) PCT No.: PCT/FR2006/001348

§ 371 Date: Jul. 21, 2008

(30) Foreign Application Priority Data
Jun. 14, 2005 (FR) 0505986

(51) Int. Cl. G06F 12/14

(52) U.S. Cl. 726/17; 726/26

(57) ABSTRACT

The process for protecting data and computer systems includes:
a step of installing at least one software agent on at least one user workstation,
a step of capturing, by the agent, information representative of effective uses of resources on the user workstation,
a step of transmitting remotely, by the agent, information representative of the effective uses of resources on the user workstation,
a step of selecting, remotely from the user workstation, authorized resources and/or prohibited resources on at least one user workstation (724, 730, 736, 742, 748) and
a step of transmitting to the workstation information representative of the authorized resources and/or the prohibited resources and
on the workstation, a step (754) of inhibiting, by the agent, the use of prohibited or non-authorized resources.

This invention concerns a process and a device for protecting computer systems and data. It applies, in particular, to the protection of data on personal computers and on computer systems in networks.

Traditional firewalls, i.e. inter-network, are placed at the entry points of networks to be protected and only check the flows passing through them. Thus they are completely blind with respect to internal attacks coming from the network protected. It is only necessary for an inexperienced user to use a modem or WIFI connection via his or her workstation or portable computer and an external attacker can benefit from this breech to carry out an attack, thus rendering obsolete the traditional Firewall system utilized, however powerful it might be. This eventuality is also possible with regard to “end-to-end” VPN (acronym for “virtual private network”) remote connections, which pass through the firewall unchecked since they are encrypted. Furthermore, traditional firewalls constitute a point of weakness in computer networks: indeed, the Firewall's breakdown automatically leads to the link being cut and the current solutions of redundant operation are costly and do not eliminate this risk absolutely. In addition, the administrator is sometimes obliged, given the emergency situations, to do without the firewall, with all the risks that entails, when the accesses managed by the firewalls block all the network flows. Traditional firewalls also constitute a bottleneck at the inter-network communications level, however powerful they might be and whatever the flow priority assignment and stratification solutions proposed. It only needs an application that is “greedy” in terms of throughput and all the other standard applications are penalized. It is noted that this fault also applies to the standard firewalling solution, in which there is no equality between flows either.

The current responses to the problems cited above are mainly based on a combination of the two solutions below:
firstly, the segmentation of internal computer networks, by installing firewalls between internal networks: this solution, which is costly and impacts the reliability and speed of the flows, imposes administration and topological constraints that significantly limit its utilization and effectiveness;
secondly, the use of several intrusion detection sensors for protection against internal attacks: in addition to its cost, this solution is faced with the problem of the increasingly wide-spread use of VLANs (acronym for “virtual local area network”) and the decreased effectiveness of IDSs (acronym for “intrusion detection system”) in high network flow situations, something that tends to be magnified with the wider use of multi-media applications and the emergence of new network technologies (known under the names Giga Ethernet or ATM, for example).

Although more than 75% of dangerous attacks have their origin in the internal network, many companies do not have effective means of controlling and protecting their network.

Other known processes for protecting data and computer systems are based on looking for the signature of viruses, worms, Trojan horses, generators of spam or spyware; the chief drawback of these processes is that fact that they are only effective after the malicious software (known as “malware”) has been installed on the computer and when the signature of this software is in its signature database, which sometimes leaves it time to deactivate the protection systems or download other malicious software. For example, 80% of companies infected by the “Sasser” worm had nevertheless installed an anti-virus protection system.

The aim of this invention is to remedy these inconveniences.

To this end, in a general way, this invention is based on the concept of the decentralization, on each user workstation, of a set of security devices/processes administered remotely, for example from a centralized console.

Thus, according to a first aspect, the present invention envisages a process for protecting data and computer systems, characterized in that it comprises:
a step of installing at least one software agent on at least one user workstation,
a step of capturing, by said agent, information representative of effective uses of resources on said user workstation,
a step of transmitting remotely, by said agent, information representative of said effective uses of resources on said user workstation,
a step of selecting, remotely from the user workstation, authorized resources and/or prohibited resources on at least one user workstation and
a step of transmitting to said workstation information representative of said authorized resources and/or said prohibited resources and
on said workstation, a step of inhibiting, by said agent, the use of prohibited or non-authorized resources.

Thanks to these features, security being decentralized at the level of each user workstation, this invention allows the information system manager to implement a suitable security policy over the whole of his or her information system, taking into account the specific needs of each user or user group, and to have greater flexibility of working than with prior state of the art processes and devices, without having to modify the topology of the computer network by separating it into virtual local networks.

According to particular features, the process as described in brief above comprises, in addition:
a step of processing, remotely, said information representative of effective uses of resources originating from at least one said agent, in order to provide aggregate use data,
the selection step utilizing said aggregate use data.

Thanks to these provisions, the information system manager can analyze the aggregate data, more summarized, in order to decide the authorizations or prohibitions to be implemented or changed.

According to particular features, the process as described in brief above comprises, in addition:
a step of transmitting, from at least one user workstation on which a software agent has been installed to a console remote from said user workstation, said information representative of effective uses of resources on said user workstation and
a step of transmitting, from said console to a server, information representative of said authorized resources and/or said prohibited resources,
the step of selecting authorized resources and/or prohibited resources on at least one user workstation being performed on said console.

Thanks to these provisions, the administration console can be mobile or multiple, the server enabling the agents to be updated in accordance with the security policy. A person in charge of a computer network's security can thus remotely monitor and control the software agents installed on the user workstations in order to prohibit the use of resources that he/she deems inappropriate or dangerous on the corresponding workstations; these resources can be specific to each workstation, common to a sub-set of workstations or to all the network's workstations. As a result of using the intermediary server between the console and the agents, the operation of the process can have increased security.

According to particular features, said resources comprise access to remote sites over a worldwide computer network, the inhibition step comprising a step filtering the electronic address of each page that the user workstation tries to access, by recognizing a predefined part of this address, filtering hypertext links present in each page that said user workstation accesses and/or filtering each page that the user workstation tries to access by recognizing a predefined sequence of symbols in a description of said page.

According to particular features, said resources comprise access to computer applications, the inhibition step comprising a step recognizing computer applications that the user workstation tries to access.

According to particular features, said resources comprise access to computer resources via local computer applications, the inhibition step comprising a step recognizing a computer resource that an application of said user workstation tries to access.

According to particular features, the process as described in brief above comprises a step determining the profile of at least one user workstation on which a software agent is installed, the selection step utilizing said profile in such a way that two identical workstation profiles are assigned the same resource use prohibitions.

According to particular features, the process as described in brief above comprises a step determining the profile of at least one user of a user workstation on which a software agent is installed, the selection step utilizing said profile in such a way that two identical user profiles are assigned the same resource use prohibitions, the inhibition step utilizing an identification of the user of the user workstation in question.

According to particular features, said resources comprise the modification of a software executable file, the inhibition step comprising a step verifying the integrity of the executable file.

These provisions make it possible to ensure that an executable file is not infected by a virus, worm or other malicious program.

According to particular features, said resources comprise the modification of the user workstation's system parameters, the inhibition step comprising a step recognizing attempts to access the system parameters of said user workstation.

For example, these system parameters comprise the registry, the task manager, the DOS (registered trademark) operating system session use, multiboot access, the installation of applications other than those referenced by the security manager.

According to particular features, said resources comprise the use of hardware resources for storage on removable media or printing of data, the inhibition step comprising a step recognizing the destination hardware for a transmission of information.

Thanks to these provisions, the leaking of information or the opening up of breeches in a company's information system can be prevented by prohibiting the use of potentially dangerous removable peripherals, such as USB (acronym for “universal serial bus”) keys, external hard disks and/or paper printouts.

The present invention envisages, according to a second aspect, a device for protecting data and computer systems, characterized in that it comprises:
at least one user workstation on which a software agent is installed, said agent being adapted to capture information representative of effective uses of resources on said user workstation and to inhibit the use of prohibited resources,
a step of processing said information representative of effective uses of resources originating from at least one said agent to provide aggregate use data,
a means of displaying said aggregate use data,
a means of selecting prohibited resources on at least one user workstation.

As the particular characteristics, advantages and aims of this device are similar to those of the process as described in brief above, they are not repeated here.

According to a third aspect, this invention envisages a process for protecting computer systems, characterized in that it comprises, for at least one communication between a first user workstation sending a request to a second user workstation a step of adding by the first user workstation, a sequence of symbols in said request, a step of determining port opening authorization, by the second user workstation, during which the second user workstation determines, according to said sequence of symbols, if a communication port must be opened to communicate with the first user workstation and, where port opening is authorized, a step of the authorized port being opened by the second user workstation.

Thanks to these provisions, the second user workstation only opens the communication port if it identifies that the first user workstation is authorized to communicate with it.

According to particular features, during the addition step said sequence of symbols is placed in the header of a data packet transmitted to the second user workstation.

According to particular features, during the addition step said sequence of symbols is placed in the header of the first data packet transmitted to the second user workstation.

According to particular features, during the step of determining port opening authorization, the second user workstation reads only the data packet comprising said sequence of symbols and does not read the other data packets transmitted by the first user workstation.

According to particular features, during the step of determining port opening authorization, the second user workstation only reads said sequence of symbols and does not read the other data transmitted by the first user workstation.

Thanks to each of these provisions, port opening authorization can be quick and dependable since the second user workstation does not have to process or store a large quantity of information before accessing the sequence of symbols necessary for the authorization step.

According to particular features, during the step determining port opening authorization, the second user workstation compares said sequence of symbols with at least one sequence of symbols that it stores in memory.

Thanks to these provisions, authorization is quick and simple.

According to particular features, during the step of determining port opening authorization, the second user workstation deciphers said sequence of symbols.

Thanks to these provisions, a malicious third-party who does not have the encryption key cannot generate a sequence of symbols allowing it to obtain a port opening on the second user workstation.

According to particular features, said addition and port opening authorization steps are performed at the start of each communication between said first and second user workstations.

According to particular features, said addition and port opening authorization steps are performed for all the computer system's user workstations.

According to particular features, during the addition step the port whose opening is requested is represented by said sequence of symbols.

According to particular features, said addition step and said port opening authorization step are performed at least for the requests, made by the first user workstation, to access one of the second user workstation's resources.

According to a fourth aspect, this invention envisages a protection process, characterized in that it comprises a step of automatically modifying a computer network's user workstation name and/or a computer network's user workstation address, the matching of the modified name and/or address with the user workstation's actual name and/or address only being known from an administrative workstation linked to said network.

According to particular features, the process as described in brief above comprises at least one step utilizing a table correlating the modified names and addresses and the actual names and addresses.

According to particular features, the process as described in brief above comprises at least one step encrypting the actual names and addresses.

According to a fifth aspect, this invention envisages a protection process, characterized in that it comprises a step of determining or selecting, for each executable file or application present on the user workstation, the resources that said executable file or application can access, known as “authorized resources”, and, in the case where the executable file or application attempts to access a resource other than the authorized resources, a step of blocking said attempt.

According to a sixth aspect, this invention envisages a protection process, characterized in that it comprises, at least during the standby periods, a step prohibiting the use of a user workstation's ports except for a port reserved for a predefined software agent, said software agent performing a step sorting communications coming to it and authorizing, or not, the port openings for a direct communication not passing via said software agent or the communication to said port by the intermediary of said software agent.

According to a seventh aspect, this invention envisages a process for protecting computer systems, characterized in that it comprises a step of selecting at least one user workstation and a step of incorporating, by software means, said user workstation into a group of user workstations possessing, between them, broader access rights than the access rights assigned to user workstations outside said group.

Thanks to these provisions, it is no longer necessary to modify hardware switches in order to create and modify groups of workstations making up a trusted network.

According to particular features, the selection step and the command for the incorporation step are carried out on a console remote from said user workstations. Thanks to these provisions, security is strengthened.

According to particular features, during the step of incorporating a user workstation into a said group of user workstations, the operation takes place on the second layer of the OSI layers

Thanks to these features, action takes place at a level below or equal to that of a firewall and below layers utilized by the TCP (acronym for “transmission control protocol”), which are layers 3 and 4.

According to particular features, during the incorporation step a MAC (acronym for “media access control”) address of the user workstation incorporated into the group is sent to every other user workstation of said group.

According to particular features, during the incorporation step an agent located on each user workstation of said group authorizes or prohibits access to at least one part of its resources, according to said MAC address transmitted by a user workstation in order to access said resources.

Thanks to each of these provisions, the resources available on workstations are isolated, these resources remaining accessible to the members of the trusted group thus created and not available to the user workstations that are not in this trusted group.

According to particular features, the process as described in brief above comprises, in addition, an additional step selecting user workstations from a said group of user workstations and a step authorizing access for each said user workstation to resources of the other user workstations having been the subject of said additional selection, said resources not being accessible to workstations of said group of user workstations not having been the subject of the additional selection.

According to particular features, a software agent on each user workstation that has been the subject of the additional selection determines, on a layer higher than the second OSI layer, if a user workstation that attempts to access a resource is authorized to do so.

Thanks to each of these provisions, a tree structure is created of groups of user workstations given access rights to resources of other user workstations located on the same branch of the tree structure, hierarchically arranged, with respect to user workstations located on other branches.

Thanks to each of these provisions, the person in charge of a computer network can create a hierarchized virtual local area network with the user workstations.

According to an eighth aspect, this invention envisages a process for protecting a computer system, characterized in that it comprises a step of installing a software agent on at least one portion of the user workstations of said computer system and an operational step during which said agent performs processing on levels 2, 3 and 7 of the OSI layers classification.

Thanks to these provisions, each software agent operates at the same time on a layer very close to the hardware, on a layer where a transmission control protocol operates and on a layer utilized by computer applications.

According to particular features, during the operational step said agent performs processing on level 4 of the OSI layers classification.

Thanks to these provisions, each software agent operates on each layer where a transmission control protocol operates.

According to a ninth aspect, this invention envisages a process for protecting a user workstation, characterized in that it comprises:
a step of selecting resources to be protected from among the resources available on said user workstation,
a step of detecting access to a protected resource and, in this case, a step of closing each external communication port of said user workstation.

Thanks to these provisions, a variable or switchable trusted perimeter, which contains the resources to be protected, can be put in place. For example, a list of trusted applications associated to each resource is defined.

According to particular features, the process as described in brief above comprises, in addition, a step detecting the opening of one of said user workstation's external communication ports and, in this case, a step of closing each protected resource.

According to particular features, during the step closing each protected resource, the content of said protected resource is backed up.

According to particular features, during the step closing each protected resource, a certificate of integrity is associated to the content of said protected resource and, during a new access to said protected resource, a step verifying the integrity of said resource is carried out.

Thanks to each of these provisions, the resources to be protected cannot be modified during an opening of the user workstation's external ports.

According to particular features, during the step selecting resources to be protected, at least one folder is selected and, during the step detecting access to such a folder, the opening of said folder is detected.

According to particular features, during the step selecting resources to be protected, at least one file is selected and, during the step detecting access to such a file, the opening of said file is detected.

According to particular features, during the step selecting resources to be protected, folders or files are selected and, during the step detecting access to such a folder or such a file, an attempt to copy said folder or said file is detected.

According to particular features, during the step closing each external communication port, communication over removable data media connectors is prohibited.

According to particular features, the process as described in brief above comprises a step of selecting applications authorized to access each resource to be protected, a step certifying the integrity of each said application, and, in the case of an application attempting to access a resource, a step verifying said application's authorization to access said resource and a step verifying the integrity of said application.

Thus, for example, a list of trusted applications associated to each resource of the machine is defined and these applications are signed to avoid the effect of a vulnerability or a modification of said application.

According to particular features, the process as described in brief above comprises a step copying or transferring from a protected resource in a buffer memory area, the user workstation's external ports therefore being closed and the resource in said memory area therefore not being protected, and a step of remote transmission from said non-protected resource, via said buffer area, by the intermediary of a said external port.

Thanks to these provisions, a sandbox is put in place comprised of the protected resources' output buffer memory area.

According to particular features, the process as described in brief above comprises a step receiving a resource, by the intermediary of an external port, in a buffer memory area, and in the case where, during a selection step, said resource is selected to be protected, a step of processing said resource to determine whether it contains malicious software, the user workstation's external ports thus being closed.

Thanks to these provisions, a sandbox is put in place comprised of the protected resources' input buffer memory area, in which said resources are scanned.

According to particular features, the process as described in brief above comprises a user identification verification step and, in the case where the user is not identified, the user cannot access the protected resources.

The fundamental and particular features of the different aspects of this invention constitute particular features of all the aspects of the present invention. In fact, for reasons of clarity, all these features have not been copied for all the processes that are the subjects of the various aspects of this invention but are intended to be combined in order to form a computer system protection process that is complex and able of countering a large number of types of attack.

Other advantages, aims and characteristics of the present invention will become apparent from the description that will follow, made, as an example that is in no way limiting, with reference to the drawings included in an appendix, in which:

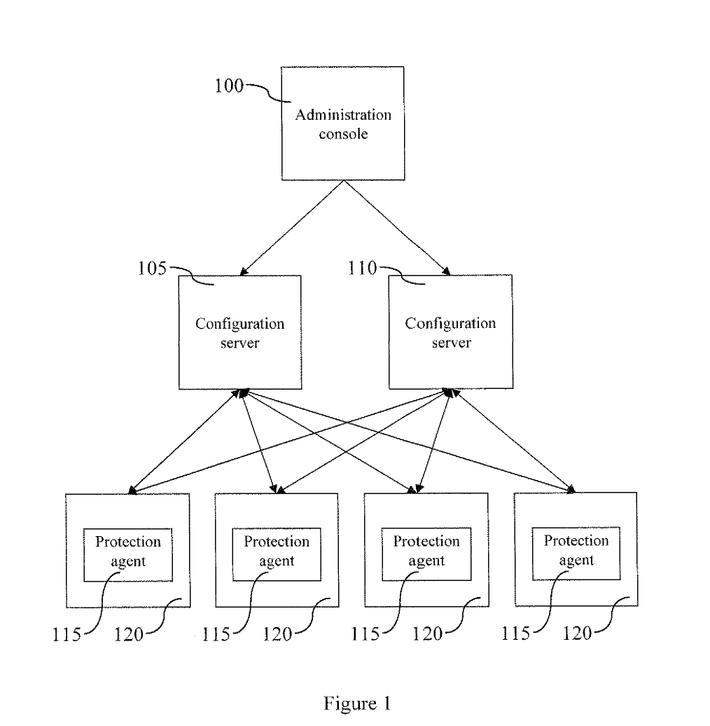

FIG. 1 represents, schematically, the architecture of the device that is the subject of this invention, in a simple computer network;

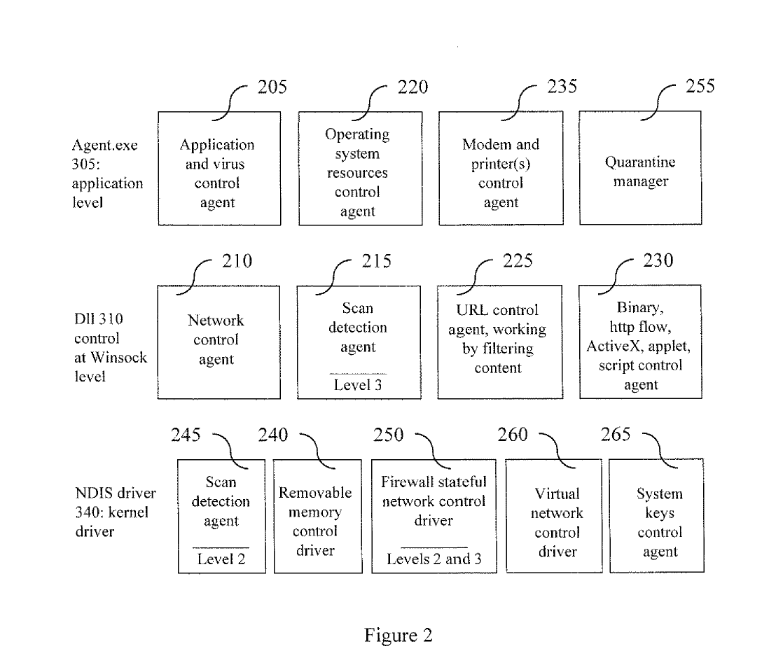

FIG. 2 represents, schematically, the components of a software protection agent installed on user workstations;

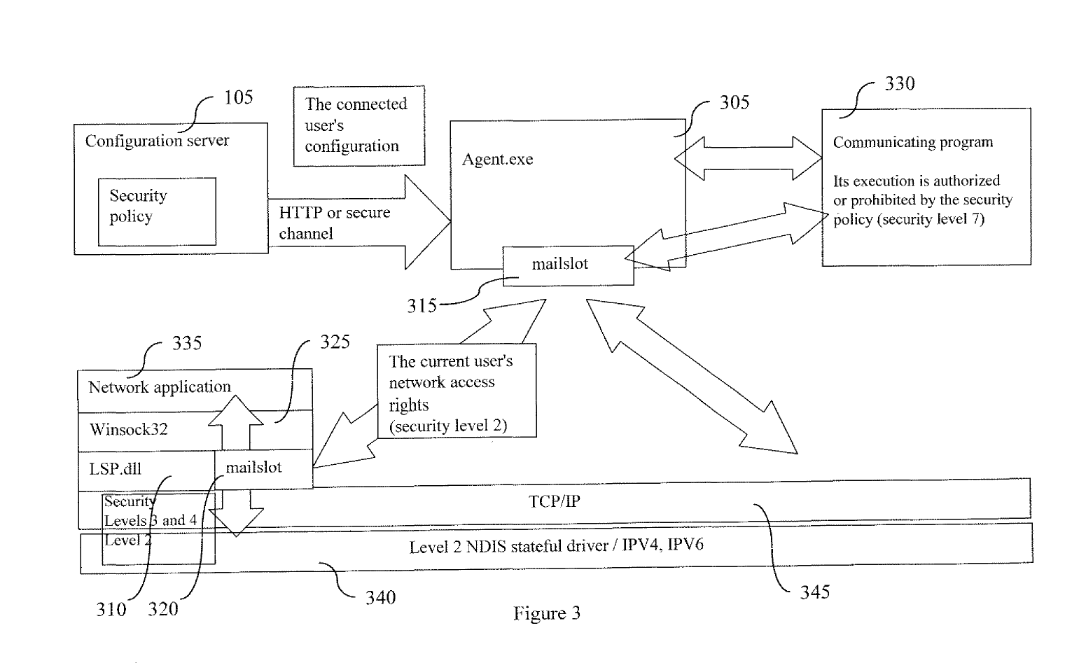

FIG. 3 represents, schematically, the communications between hardware and software components of a device that is the subject of this invention;

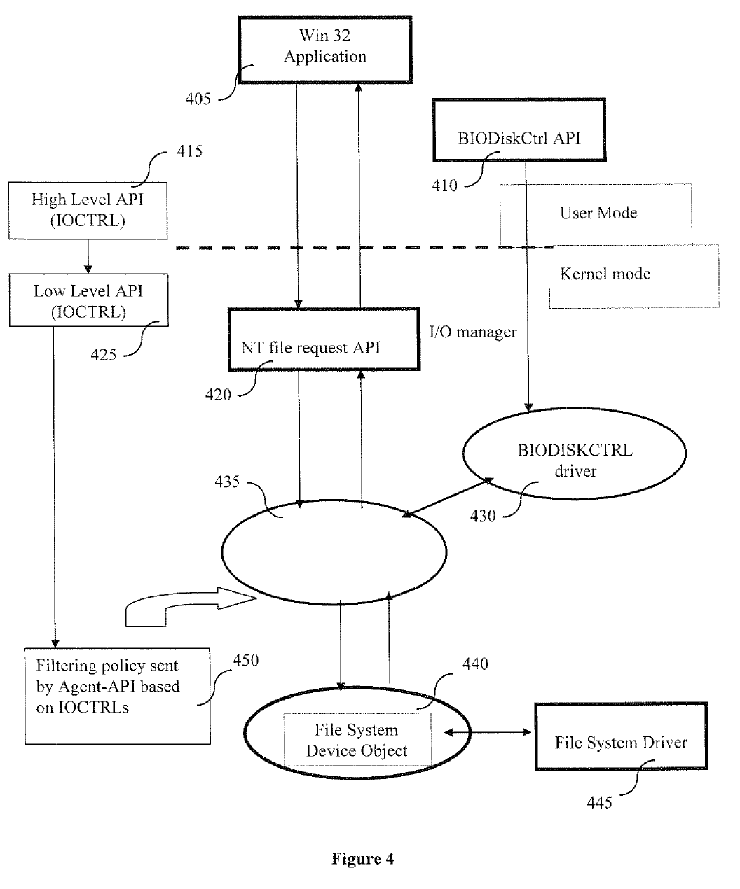

FIG. 4 represents, schematically, the internal architecture of a filter module utilized by a protection agent adapted to Windows XP, 2000 and 2003 (registered trademarks) operating systems;

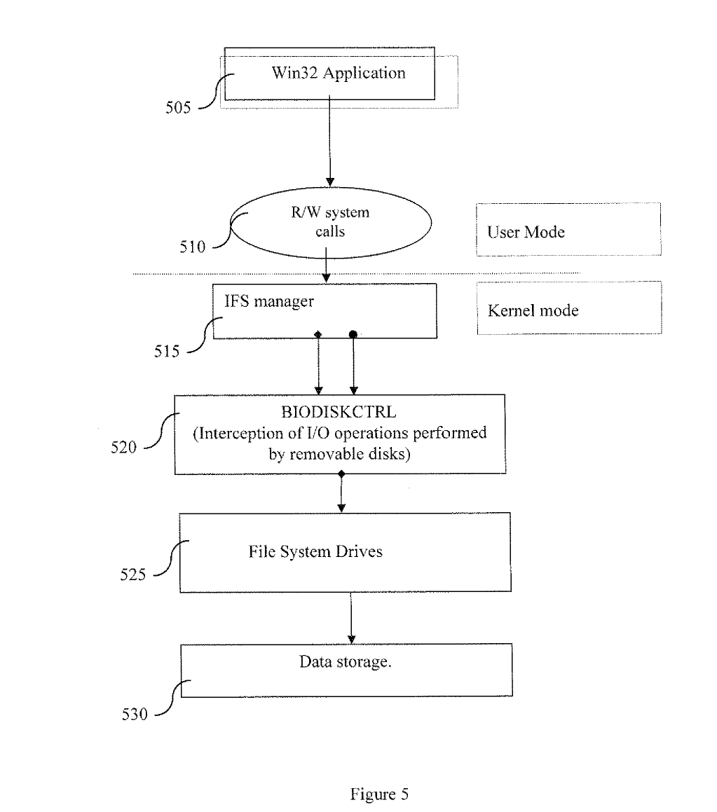

FIG. 5 represents, schematically, the internal architecture of a filter module utilized by a protection agent adapted to Windows 95 operating systems;

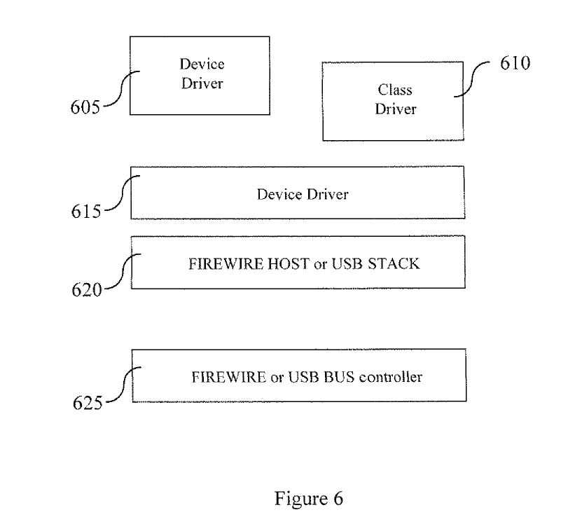

FIG. 6 represents, schematically, the internal architecture of a filter module utilized by a protection agent adapted to any operating system;

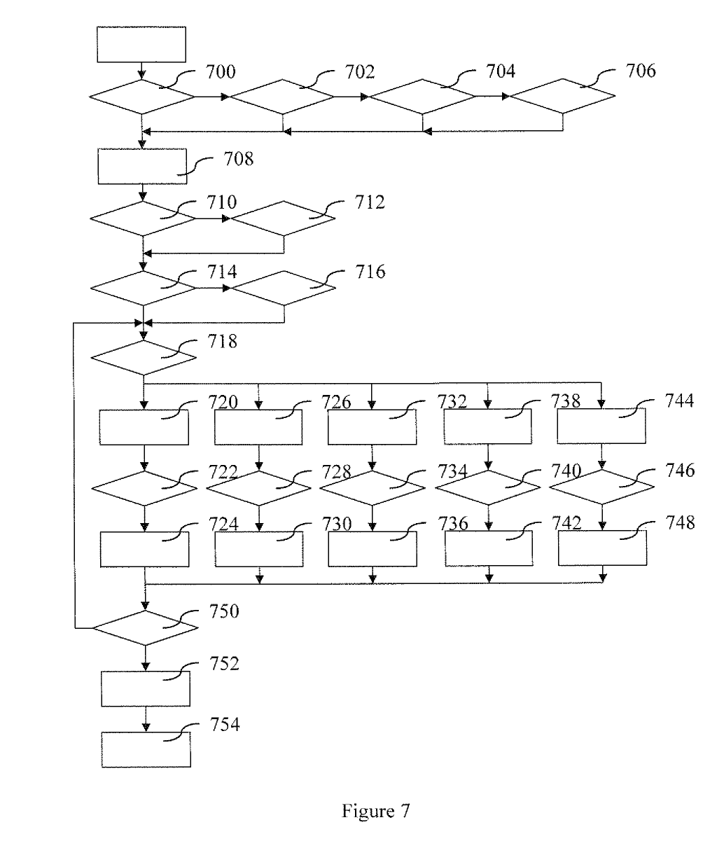

FIG. 7 represents, in the form of a logical diagram, steps utilized in a particular embodiment of the process that is the subject of the present invention,

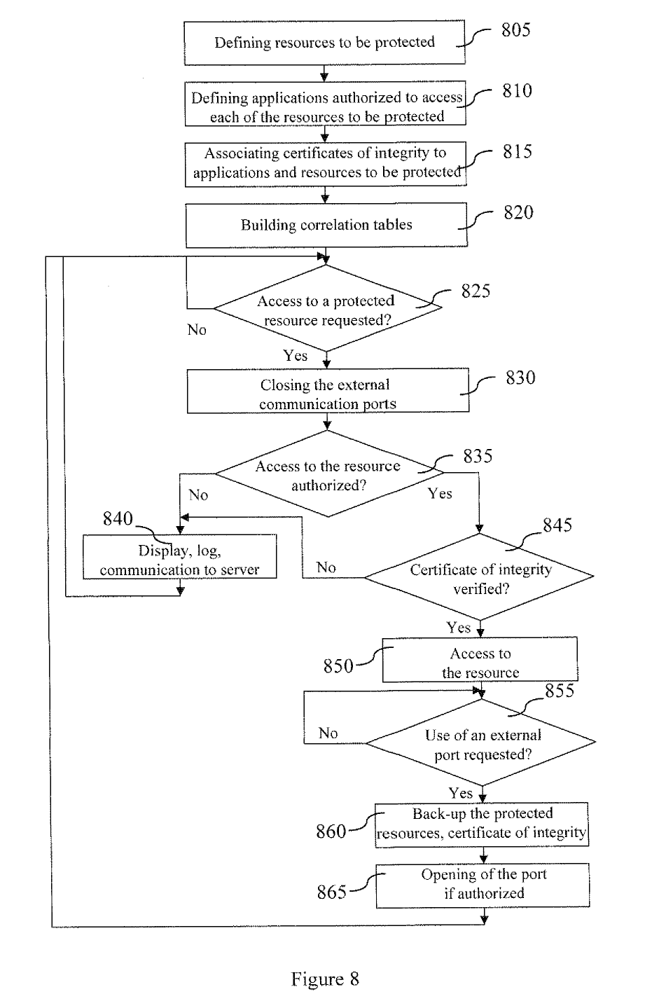

FIG. 8 represents, in the form of a logical diagram, steps utilized in a particular embodiment of the process that is the subject of the present invention,

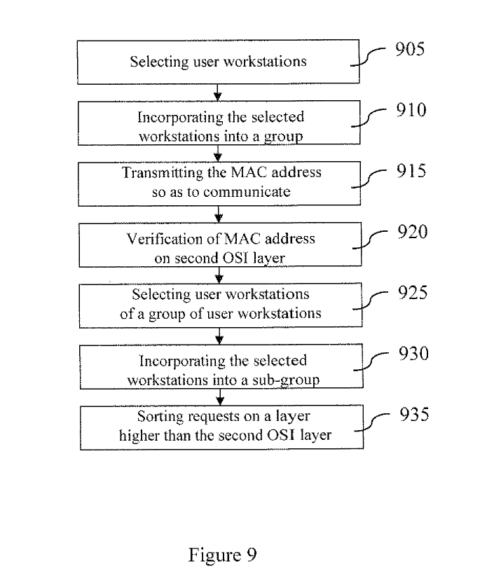

FIG. 9 represents, in the form of a logical diagram, steps utilized in a particular embodiment of the process that is the subject of the present invention and

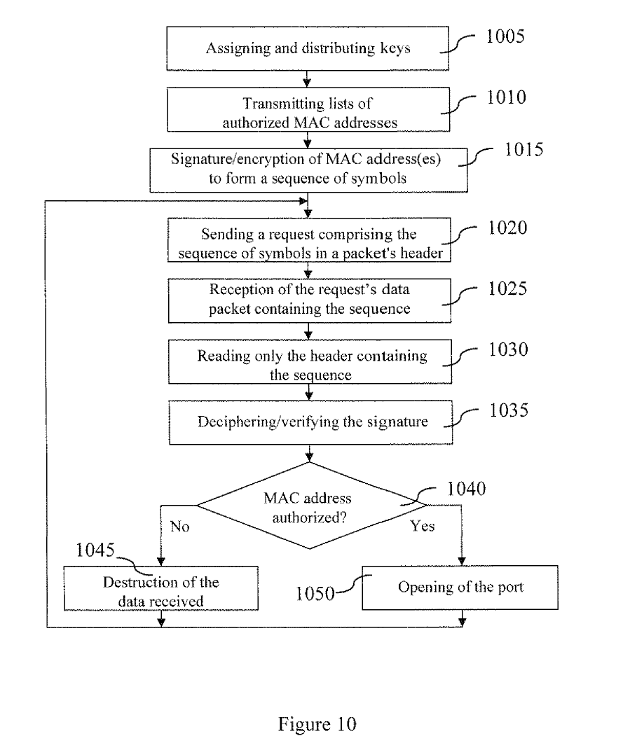

FIG. 10 represents, in the form of a logical diagram, steps utilized in a particular embodiment of the process that is the subject of the present invention.

Throughout the description the terms “security” and “protection” are used with the same general sense.

Throughout the description, the term “user workstation” principally designates a terminal linked to a network and comprising a general-purpose computer. It equates to the term “machine” sometimes used by IT staff and may also include a computer system's various servers.

FIG. 1 shows an administration console 100 that communicates with two configuration servers 105 and 110, which are themselves in communication with four protection agents 115 installed on four user workstations 120.

The administration console allows the person in charge of security for the computer network comprising the console, the servers and the user workstations to define the security strategy for all of the user workstations, for a portion of the user workstations and/or for each user workstation taken individually. Once this security strategy has been defined, the administration console transmits it to the configuration servers so that the protection agents are configured in accordance with the security strategy that applies to them.

The decentralized functions at the level of the user workstations 120, i.e. in effect at the level of the software protection agents 115 that are installed there, can comprise, in particular:
authorization or not to access a certain Internet, Extranet or Intranet site, by using a URL (acronym for “universal resource locator”) electronic address filter, by processing URLs or key words likely to be present in the URLs or pages to which they give access;
authorization to access and launch applications available on the user workstation;
application Firewalling, which consists of authorizing or not an application to access a computer resource that is internal or external to the company's network;
compartmentalizing each user profile to a set of computer resources, i.e. not giving it access to resources other than those assigned to it;
checking the integrity of all the executable files, making it possible to ensure that an executable file is not infected by a virus, worm or other malicious program;
checking and monitoring the workstations by prohibiting users from changing their workstation's system parameters (registry, task manager, DOS (acronym for “disk operating system”) session use, access to multiboot, i.e. launching several operating systems, to install applications other than those indicated by the administrator);
proactively detecting malicious actions and
preventing the leaking of information or the opening up of breeches in a company's information system by prohibiting the use of potentially dangerous removable peripherals (USB key, external hard disks, for example).

To administer and utilize the security strategies and supervise the company network, the protection device comprises three basic components (generally known as “3-tier architecture”):
the administration console 100, from which the security policies are defined;
at least one configuration server 105, 110 which enables the console to deploy and store the security strategies defined and utilized by the computer system administrator;
an agent embedded on each user workstation (local or mobile), on each server of the company's local network or front-end server with regard to the Internet (web or mail server) traditionally installed in the company's DMZ (acronym for “DeMilitarized Zone”).

It should be noted that the configuration servers are not necessarily servers utilizing a “Windows” (registered trademark) operating system; the protection system is installed equally well on servers utilizing, for example, a “Windows” operating system as “Unix” (registered trademark), in the broadest sense of the term, “Linux”, “Freebsd”, “OpenBsd”, “Macintosh”, “Solaris” (registered trademarks). Moreover, for redundancy reasons, it is possible to mix different types of configuration servers utilizing different operating systems, allowing the administrator to deploy the protection system whatever the operating systems of the computer system's infrastructure servers.

Thus, in a schematic way:
the console 100 constructs the security policy,

the configuration server(s) 105, 110 are responsible for distributing and storing the protection strategy or strategies and
each agent 115 executes the security policy and notifies in the event of malicious acts.

Regarding the operation of the agent 115 with respect to configuration servers 105, 110, it is noted that, depending on the embodiments, either the server pushes the security policy to the agent, i.e. the server 105, 110 transmits to each agent 115 a configuration request so that the agent 115 goes to find its configuration on a configuration server, or the agent 115 contacts the configuration server 105, 110, in order to update its configuration according to a schedule defined by the administrator.

The agents 115 are programmed to operate under different operating systems (for example all the Microsoft Windows 95, 98, ME, NT4, 2000, XP, 2003 (registered trademarks), Unix (registered trademark), Mac (registered trademark) and other operating systems).

The agent 115 only authorizes the running of an application on the corresponding user terminal if this application has been authorized by the configuration server 105, 110 for the user terminal in question, for a sub-set of terminals to which this user terminal belongs or for all user terminals.

As is shown, this invention is adapted, in the embodiments described here, to operate on a network having a number of different types of computers in which different operating systems or different versions of the same operating system are installed.

This heterogeneity extends to various modules listed below, each having a specific function, which we will detail more precisely in the rest of this document:
the web control module;
the execution control module;
the network control module;
the system control module, comprising
   resource control and
   OS control;
the intrusion control module, comprising
   the local services control module;
the IP (acronym for “internet protocol”) filter module, comprising
   the remote address control module and
   the remote service control module; and
the log, or traceability, policy module.

These various modules enable control of the user environment, including system parameterization of the user workstation, use of system commands, software or software packages, access to local and remote network services, while taking into account the specific profile(s) of each user having access to these workstations or server and also to mobile workstations that are protected against various types of attacks (network virus, worm, Backdoor, Spyware, phishing, etc) even when the machine is not connected to the company's network, for example for mobile portable computers outside the company.

With respect to creating security policies or strategies, before starting to define the configuration of the security policies, it is necessary to:
declare the users and the groups to which they belong:
   either manually, i.e. by entering each connection “profile”,
   or by importing the list of users from an LDAP (acronym for “lightweight directory access protocol”) directory or Active Directory,
   or via collection, i.e. waiting until the agents 115 installed on the user workstations 120 transmit to the administration console 100 the different “logins” (user names) used by the users,
associate a set of users or a specific user to each “security policy”; for example, the administrator associates all the company's secretaries to the security policy that relates to a user group called “the secretaries” and associates all the staff of the accounting department to the security policy that relates to a user group called “the accounting department”, the profiles forming part of two sub-sets, benefiting from the authorizations of each sub-set;
prepare lists of applications and URL (acronym for “uniform resource locator”) electronic addresses that are authorized (“whitelist” operation) or prohibited (“blacklist” operation) in order to parameterize the security policies
   either manually, by entering the electronic addresses of authorized or prohibited hypertext links, or sequences of symbols that are prohibited in these electronic addresses, or by using lists of prohibited addresses or sequences of symbols provided by third-parties,
   or dynamically, by collecting, thanks to protection agents deployed on the workstations, the various URL electronic addresses entered or utilized (for example by means of hypertext links) by executable programs used by the users and by assigning access authorized to some of these addresses and access prohibited to others.

The various security policies defined for the implementation of this invention are presented in a way that is ergonomic and easy to learn for a user who is inexperienced in security matters, and are based on the concepts of
whitelist (list of explicitly authorized resources),
blacklist (list of explicitly prohibited resources),
all authorized (assigning access authorized to resources not on the blacklist),
all closed (assigning access prohibited to resources not on the whitelist), appropriate to each module.

These security policies defined by the security administrator can be implemented on different levels:
either globally, i.e. for all the company's users,
or for a department or a group of individuals (for example, for the accounting department),
or for a category of individuals (for example, one category or profile covering the secretaries, another covering the directors, another the interns, etc),
or for a single user.

It is noted that the administrator's security logic (i.e. the definition of categories or profiles) can be different from the company's organizational logic. It is noted that, for this reason, the protection system that is the subject of this invention makes use of the LAN (acronym for “local area network”) IP (acronym for “Internet protocol”) address in order to identify a user workstation that can be accessed on the company network. In the case where the protection agent 115 is not installed on a user workstation, this is shown with a specific status on the network mapping screen displayed on the console 100, and can be immediately considered to be a “suspect” workstation by the security administrator.

The software uses various mechanisms in order to draw up the list of users controlled by the protection system:
the first mechanism for defining a user profile consists of manually entering on the administration console the user name, more generally called the “login”, used by the user to identify him- or herself on the user workstation or on the company's computer network,
the second mechanism for defining a user profile consists, if the company has this, of interconnecting the protection system to the company directory (for example, Active Directory, the Windows 2000 & 2003 operating systems directory) or LDAP, a specialized database, the principal function of which is to be a directory capable of returning one or more attributes of an object thanks to multi-criteria search functions—for example, a person can have, in his or her profile, an item of data indicating that he or she is of director level and is assigned to the accounting department.
the third mechanism is utilized when the protection agent is installed on the user workstation: if the “login” does not exist on the console, it is automatically integrated into the protection system's internal directory, making it possible to take into account the workstations that are not referenced in a company directory (LDAP or Active Directory) or when the authentication of the user is done locally on the user workstation and not via an authentication server, generally known as “domain controller” in the Microsoft universe.

It is noted that each protection agent 115 applies, by default, what is called a “core” security policy preventing worms, Trojan horses, spyware or network viruses from operating or replicating themselves. To do this, the agent 115 uses a check of each executable file's integrity, i.e. each executable file is associated to an integrity certificate and this is verified each time the executable file is launched.

Each protection agent 115 is split into several modules, as shown in FIG. 2, which allows it to control and operate at several levels on the operating system that it has to protect.

In a particular embodiment, these modules comprise:
an antivirus and application control module 205, utilized at the application level,
a network control module 210, utilized at the Winsock level,
a scan detection module 215, utilized at the Winsock level and at the third layer of the OSI (acronym for “open systems interconnection”) layer classification,
an operating system resources control module 220, utilized at the application level,
a URL electronic address control module 225, working by filtering content, utilized at the Winsock level,
a binary, http (acronym for “hypertext transfer protocol”) flow, ActiveX, Applet and script control module 230, utilized at the Winsock level,
a modem and printer control module 235, utilized at the application level,
a removable memory (diskettes, external hard disks, memory cards, keys known as “USB” keys from the name of the port to which they are connected, for example) control module 240, utilized at the Kernel driver level,
a scan, i.e. attempt to map the computer network, in particular by stealth, i.e. not providing any acknowledgement of receipt of the responses received from user workstations 115, detection module 245, utilized at the Kernel driver level and on the second layer of the OSI layer classification.
a stateful firewall network control module 250, utilized at the Kernel driver level and on the second and third layers of the OSI layer classification,
a module managing resources put into quarantine in application of the security policy 255,
a virtual network control driver module 260 that utilizes the steps shown in FIG. 9 in order to realize trusted networks, or groups, and sub-networks, or sub-groups, and
a system key control module 265, which inhibits certain keys or key combinations having a meaning for the operating system, for example Ctrl+Alt+Del, the “windows” key (function known as “keyboard hooking”).

It is noted that the OSI classification comprises seven layers that, starting from layer 1 and in order, are concerned with physical components, links, network, transport, sessions, presentation and applications.

Below, with regard to FIG. 3, the controls operated at each level or on each OSI layer are described in a particular embodiment of the present invention. This FIG. 3 shows the configuration server 105, which has provided, over a secure channel or via https (acronym for “hypertext transfer protocol secure”) transfer, the security policy parameters (i.e. an item of information representative of the authorizations and/or prohibitions and the operating mode of the agent) to an executable file 305 “agent.exe” forming part of the protection agent 115 installed on a user workstation or machine 120.

A communicating program, for example Outlook (registered trademark), use of which is authorized or prohibited in application of the security policy, attempts to communicate with an external server (not shown). It interrogates the executable file 305 to determine whether it is authorized to operate. By an operation on the level 7 OSI layer, the executable file determines, according to the security policy parameters, whether the program 330 is authorized to operate. If not its operation is inhibited, via an action on the seventh OSI layer and, for preference, a message warns the user of this inhibition. If yes, as is supposed here for the rest of the description, the executable file 305 assigns a communication port to the program 330, according to the user's network access rights defined by the security policy, i.e., in particular, whether this user has the right to communicate over the network, and operates on the third and fourth OSI layers, the TCP/IP protocol operation layers.

The executable file 305 then generates an encrypted rule for the use of the second OSI layer and possibly the third and fourth OSI layers, and an encrypted rule for the fourth OSI layer. A DLL (acronym for “dynamic link library”) 310 verifies compliance with the rule that solely concerns the fourth OSI layer. A level-2 stateful NDIS (acronym for “network driver interface specification”) driver verifies compliance with the rule concerning the second OSI layer and possibly the third and fourth OSI layers.

Thus the security rules are applied above and below the third OSI layer, which corresponds to the TCP/IP layer, particularly vulnerable.

It is noted that “stateful” signifies the ability to keep the current connections in memory, in a table of states. This ability makes it possible to know that such-and-such a client (identified by a client IP address) to such-and-such a server (identified by a server IP address) is in the process of doing such-and-such (connecting source port “x” to destination port “y”).

Agent 115 comprises the executable file 305 (layer 7), the dll 310 (layers 3 and 4) and the NDIS driver 340 (layers 2 to 4). For preference each user workstation is equipped with two agents 115, which carry out self-checking and mutual regeneration in the event of alteration, this being detected, as indicated above with regard to the other executable files or applications, by utilizing and verifying integrity certificates (for example, in the form of message digests or hashes of the content or file to be certified).

Communication between the executable file 305, on the one hand, and the NDIS driver 340, the dll 310 and the network application 335, on the other hand, is carried out by the intermediary of mailslots 315 and 320. It is also noted that a mailslot is, to some extent, a mailbox where only the recipient of the messages has the key. Communication by the intermediary of a mailslot is therefore only in a single direction and asynchronous.

In the rule generated by the executable file 305, communication is only authorized for a single remote and/or local MAC (acronym of “media access control”) address (there is one MAC address per network card). The NDIS driver 340, operating on the second OSI layer, decodes the rule and applies this security rule to layers 2 and 3 and, for preference, 4. Similarly, the return of data is filtered according to MAC addresses.

In the description, “application level” refers to all the controls based on the Windows API (acronym for “advanced program interface”) and on the registry of the various operating systems on which the agent is installed. This control level is used by the protection system of the application implementing this invention to:
control the execution of programs authorized or prohibited by the administrator,
sign the executable files of the workstation to guarantee their integrity with regard to worms, viruses, Trojan horses, Spyware, Backdoor, Malware, etc and
control the system resources and prevent modifications of the machine's system parameters by the users (for example by masking the configuration panel, the “execute” command, the task manager, network environment, the machine's host name, the task bar, by prohibiting file sharing, alternative operating system “boots”, use of MS/DOS, registered trademarks, etc).

“Winsock level” refers to all the controls based on the Winsock layer (compression of Windows Sockets) 325 (FIG. 3) well known to people in this field. In installing the protection agent 115 on a user workstation, an LSP (acronym for “layered service provider”) called “LSP.dll” is also installed, which is loaded with the DLL winsock32.dll in charge of the network processes, this latter being provided by the Microsoft operating system. In order to intercept all the network flows of the applications and apply to them the security policy dictated by the software called “agent.exe” 305 implementing the protection agent, software that, itself, downloads the security policy to be applied from the configuration server(s), our LSP uses a winsock32 API “hook”.

Communication between the executable file “Agent.exe” 305 and the DLL “LSP.dll” 310 is carried out via “mailslots” 315 and 320, as shown in FIG. 3. The “mailslots” are like mailboxes which only the owner has the key of. Everyone who knows the box's address can leave messages in it, but only the owner can read them.

This control level is used by the protection agent 115 to:
control the authorized or prohibited access URL links for the user, analyze the content of web pages by content filtering and find out whether they contain prohibited content, for example key words, that does not correspond to the company's security policy,
control the user workstation's local network services accessible or prohibited via the LAN network or internally, by controlling the port and IP address,
control the remote network services to which the user has or has not access rights,
detect port scans allowing a malicious person to identify which are the services offered, and potentially vulnerable, by the targeted user workstation—this is generally the first reconnaissance step carried out by a malicious person in order to insert themselves into a machine and
authorize or prohibit the downloading and installation, by the intermediary of browser software or web browser, of potentially dangerous Active X or Java script or applets.

This control level is used by the protection agent 115 to control access to removable memories and, more precisely, to the IRP (I/O request packet) filtering engine.

“Kernel Driver” level refers to a “driver” which operates with the operating system kernel and which, in the embodiment detailed here, intercepts each access to a disk and authorizes or prohibits it, according to the configuration that it receives from the executable file “agent.exe”. This mechanism is performed by the intermediary of IRPs, means of communication between the application and the driver. This control level is used by the protection agent to control the use of removable peripherals, for example “USB” keys, “USB” external disks, memory cards, diskettes, Firewire,

For this purpose, the protection agent 115 uses two different methods depending on the operating system on which the control is performed.

Internal architecture of the IRP filtering engine (removable disk I/O filter driver), data protection module supported on Windows NT, 2000, XP, 2003 platforms.

The internal architecture of the filtering module of IRPs carried out on the removable disks (read and/or write from and/or to the hard disk) is shown in FIG. 4, which specifies the position of the engine in the internal part of the system.

FIG. 4 shows, below a broken line, the kernel mode and, above this line, the user mode. The win32 application 405, the “BioDiskCtrl” disk control API 410, the “NT File Request” API 420, the “File System Device Object” 440 and the “File System Driver” 445 are well known to people in this field utilizing the Windows XP, 2000 and 2003 operating systems.

The removable disk driver receives its filtering policy for disk accesses from the agent 115, from a “Low Level API” internal interface 425 developed with specific commands (IOCTRL: specific IRPs). IOCTRLs 415 and 425 represent the sole interface between the agent 115 and the peripheral driver.

The application 405 communicates with the API 420, which itself communicates with the object 440 that applies the filtering policy sent by the agent 115 based on IOCTRLs 450 for controlling a file control driver 445.

The “kernel 32.dll” dll provides native NT API calls between the application 405 and the API 420. The BioDislCtrl driver 430 provides orders to close communication with removable data media readers, by the intermediary of BiolOCtrl.

The “NT file service” functions construct an input/output request (IRP) and initialize it with all the information to describe the request. Then it calls the I/O Manager to send the IRP to the removable media reader's file system.

The IRP requests are transferred to the BioDiskCtrl driver by the intermediary of the “BioDiskCtrl device object” 435. The pilot decides to pass or not pass the request to the associated file system in response to the instruction sent by the user-level API. The IRP request is transferred to the file system driver by the intermediary of the “file system device object” when the “BioDiskCtrl” driver 430 allows it.

FIG. 6 represents the internal architecture of the IRP filtering engine (removable disk I/O filter driver), data protection module supported on Windows 95, 98 and ME platforms.

The window application 505, the R/W system calls 510, the IFS manager 515, the file system drivers 525 and the data storage means 530 are well known to people in this field utilizing the Windows 95, 98 or Me operating systems. The data protection engine for the Win 9X environment is based on an internal “BioDiskCtrl” layer 520, which is interposed between the components 515 and 525 and which intercepts input/output requests and operations made by the removable memories. The communication between the agent 115 and the “BioDiskCtrl” layer is performed in the same way as described with regard to FIG. 4, by the intermediary of IOCtrls.

A detailed explanation is given below of the various modules utilized by the agents 115, configured by the configuration servers according to the security strategy defined on the administration console.

The web control module 225 or URL electronic address control agent: in order to configure the control of the use of the web, Intranet or Extranet servers, the protection agent 115 utilizes a system of whitelist and/or blacklist/authorize all/block all, detailed earlier. Each of the whitelists/blacklists utilized can be comprised of various mechanisms and completed, or not, by use of a system of key words defined by the administrator (for example, entry of the word “sex” will prohibit web pages containing the word sex from being displayed).

The manual entry of a link or URL electronic address present in one of these two lists is checked to authorize, or not, access to the resource defined by this link. These lists can also be completed by behavioral analysis of the website use made by each of the users and reported by the agents 115 deployed on the user workstations.

One of the problems that this invention answers is the difficulty of knowing the web use by the members of a community who, through assignment of functions in the organization, do not have the same needs but equally risk abusing the means made available to them by the organization.

The agent of protection 115 present on a user workstation captures each use of the web by each of the users, including:
the name or an identifier of the user,
the name or an identifier (address on the network) of the user workstation,
the URL electronic addresses visited,
the start and end times of the visit, comprising the date, hour, minutes and seconds,
for each electronic address, the source address and the destination address,
including when access to an electronic address has been refused.

These data are transmitted to the administration console 100 and presented on the administration console 100 in an aggregated way, by person, by user workstation, by groups of people (for example by hierarchy level) or positions (for example by department). The number of connections (or connection attempts) is shown with respect to each URL electronic address in order that the administrator can research the addresses that interest him/her according to this number.

Based on these data, the protection system administrator can define a blacklist on the administration console 100. As indicated earlier, this blacklist can be common to all the people in the company or all the user workstations or only concern a sub-set of this set. For example, the accounting department can have the right to access electronic addresses or network services (for example, FTP, Mail etc) that are prohibited to the research and development department and vice versa.

The protection system administrator can also prohibit certain types of browser operation. For example, he/she can prohibit, for one person or user workstation or for a group of people or workstations, Java (registered trademark) applets from operating, or popup windows from being displayed, or poison applets, ActiveX or malicious scripts from being downloaded or authorized to be launched, or not, or photo or video files integrated into pages accessible on the network from being downloaded or read.

In addition, if the company has subscribed to services providing blacklists, these lists are proposed to the protection system administrator, said administrator being able to apply them and being able to authorize their automatic update.

In a variant, the blacklists and/or whitelists are transmitted by the system to a knowledge pooling server (not shown) and each company can receive the results from processing these blacklists, in the form of recommendations common to various companies in one single field of business or to all companies. This pooling of authorized or prohibited resources enables an effective fight against a fraud technique known as “Phishing”, which consists of sending a request to a large number of recipients, pretending to be someone else, to connect and update information, under a pretext that is plausible for some recipients, for example to repair a loss of bank or subscription data.

The network control module 210: this application firewall authorizes, or not, the applications to access a network resource, on input or output. In addition to capturing URL links visited on the web or on the Intranet and Extranet networks, as mentioned in the above paragraphs, this module captures all the network applications that perform network connections. The network control module 210 transmits this traceability information, called “access logs”, to the administration console 100 where these data, aggregated or not, can be consulted by the administrator, thus enabling him/her to decide whether to authorize, or not, the use of these applications. Access logs can be reported at group level, i.e. aggregated for the members of a group of users, or for one user.

Once the agent 115 is configured with respect to this type of authorization, on output the agent 115 authorizes, or not, the external access requested by a person. On input, the agent 115 authorizes, or not, by filtering IP addresses (see below), a third-party workstation or an executable file to access a resource available on the user workstation where the agent 115 is installed.

The execution control module 205. As mentioned previously, each agent 115 deployed on a workstation begins by digitally signing the set of executable programs available on that user workstation. This set becomes, in principle, the basis of the workstation's application database. If a new program is installed on the user workstation, there are several mechanisms available to the administrator. The digital signature mechanism makes it possible to:
either automatically sign a new executable file—typically when updating the system or applying a security patch,
or to block execution of this program,
or to block its execution and put it in quarantine until the administrator signs or rejects this new program, thus allowing any suspect file to be blocked.

In a variant, for each executable file, its previous version is archived so as to be able to restore it.

The execution control module 205 of each agent 115 captures each utilization of each executable file and provides the administration console 100 with the data concerning the time, the workstation configuration, the other executable files in operation on the user workstation at the same time as the executable file in question and the person using the workstation.

The administrator can then examine all these uses of executable files by workstation, by person, or by group, so that the administrator can decide whether the utilization of the executable file is authorized or not, for each workstation, person, group of workstations or group of people.

The system control module 220 concerns the system environment of the workstation, its operating system and the peripherals controlled by the operating system, For example, for a person, a user group or all users, the administrator can control access to such-and-such a peripheral by authorizing, or not, the installation (of modems or printers) or the recording on removable memories (memory keys known as “USB keys”, diskettes, external disks, writable CDROM, DVD disks).

In a variant, this module 220 creates a driver allowing USB & Firewire connections to be filtered and the operation of non-authorized USB/Firewire peripherals to be prohibited. This function is mainly performed by a filter driver intercepting all the requests sent to the peripheral's driver and prohibiting the start-up of a peripheral not authorized or not referenced by the administrator in charge of the computer system security.

This USB or Firewire peripheral control driver makes it possible to authorize access to certain peripherals, either individually (using the VID_PID pair), or by peripheral class. For example, it prohibits WIFI USB keys being installed on all the computer network's machines.

To do this, the connection process is as follows:
physical connection of the peripheral, by the user,
enumeration of the peripheral by the Firewire or USE stack, by the operating system,
loading of an associated driver, by the operating system,
creation of a peripheral instance by the associated driver, by the operating system, call intercepted by the filter,
retrieval of the peripheral's descriptors “Device Descriptor” and “Configuration Descriptor”, by the filter driver,
comparison of the USB peripheral identifiers with a list in a file centralized and visible with the administration console 100 and sent by the configuration servers on the agents 115,
comparison of the USB/Firewire peripheral class identifiers with a list in a file centralized and visible with the administration console 100 and sent by the console to the configuration servers 105 and 110 on the agents 115,
if the peripheral is not on any list, the peripheral is rejected and marked as not started up in the peripheral manager and an alert is reported on the administration console 100,
if the peripheral is authorized in one of the lists, the request is passed to the peripheral driver, which then operates normally.

In the case of a USB or Firewire storage peripheral (Key, External Hard Disk, etc), the administrator keeps control over writing by means of three possible commands, with explicit names: “All authorized”, “Data import prohibited” and “Export to the peripheral prohibited”.

The USB/Firewire peripheral control mechanism operates each time a peripheral is inserted. To this end, this mechanism comprises a recorded filter driver for the USB or Firewire class as “Lower Filter Driver”. It is thus called by the operating system before any Firewire or USB stack call, as shown in FIG. 6.

The driver filters all the IRPs sent by the peripheral driver 605 to the Firewire or USB stack 620.

When a PNP_START_DEVICE type of IRP is received by the filter, this carries out the following actions, given following an organization known to people in this field:

PNP START DEVICE (IRP)

Retrieval of the Device Descriptor
Back up the VID/PID pair
If CLASS, SUBCLASS, PROTOCOL are other than “0” or “FF”, then back up
Retrieve the Configuration Descriptor
Extraction of the fields CLASS, SUBCLASS, PROTOCOL of the first interface found
Search in the file of the general authorizations of the VID/PID pair

If authorized

Request accepted and peripheral setup accepted
Return

Search in the file of the general authorizations of the CLASS, SUBCLASS, PROTOCOL pair of the
Interface Descriptor
IF Authorized

Request completed successfully and setup of peripheral
Return

ELSE

Request refused with Error and peripheral deactivated.
Return

The lists of authorized peripherals are encrypted locally and on the configuration servers by the same algorithm as that used by the securization system.

The peripheral management user Interface: when a USB or Firewire peripheral setup fails, the agent 115 on the workstation notifies the user that his/her USB or Firewire peripheral has been rejected by the company's security policy and the alert message is displayed during a period of time that can be customized from the administration console 100.

FIG. 7 shows steps utilized in a particular embodiment of the process that is the subject of the present invention, during the creation of a security policy.

During a step 700, it is determined whether the users are referenced in the administration console. If yes, you go to step 708. If not, during a step 702, it is determined whether the administrator created the references of the users manually, by data-entry. If yes, you go to step 708. If not, during a step 704, it is determined whether the administrator is importing users from a user directory. If yes, you go to step 708. If not, during a step 706, it is determined whether the administrator derives the references of the users from information supplied by the agents deployed on the network workstations and you go to step 708.

During the step 708, a report is ordered, from the protection agents 115, even non-active, of the resource uses on the user workstation to which they are associated and, for the active agents, of the refused accesses to resources. During this step 708, these data are aggregated, by workstation, by user, by group of users and for all user workstations and by agent module concerned.

During a step 710, it is determined whether a security policy has been created and is going to be edited by the administrator. If yes, you go to step 714. If not, during a step 712, the administrator creates a security policy, i.e. a file that will identify the policy and carry its application parameters. When the administrator has confirmed the creation of the security policy, you go to step 714.

During the step 714, it is determined whether the security policy must be associated to users. If yes, you go to step 716, during which the security policy is associated to users, either for all the user workstations, for sub-sets of user workstations, for user profiles, for specific user workstations, for users identified by their logins (or user names) and/or passwords or by any other means of identification (e.g. biometrics, memory card) utilized in the company, for example by means of an authentication server.

If the result of step 714 is negative or following the step 716, during a step 718 the administrator chooses the protection agent's protection module.

If, during the step 718, the administrator chooses the web control module, the different possible control modes are displayed, step 720. Then he/she selects the control mode, step 722, and he/she parameterizes the web security policy, step 724, possibly based on the display of the reported resource uses of the agents of the users or user workstations in question, then you go to step 750.

If, during the step 718, the administrator chooses the execution control module, the different possible control modes are displayed, step 726. Then he/she selects the control mode, step 728, and he/she parameterizes the execution control policy, step 730, possibly based on the display of the reported resource uses of the agents of the users or user workstations in question, then you go to step 750.

If, during the step 718, the administrator chooses the network control module, the different possible control modes are displayed, step 732. Then he/she selects the control mode, step 734, and he/she parameterizes the network control policy, step 736, possibly based on the display of the reported resource uses of the agents of the users or user workstations in question, then you go to step 750.

If, during the step 718, the administrator chooses the system control module, the different possible control modes are displayed, step 738. Then he/she selects the control mode, step 740, and he/she parameterizes the system control policy, step 742, possibly based on the display of the reported resource uses of the agents of the users or user workstations in question, then you go to step 750.

If, during the step 718, the administrator chooses the IP address filter module, the different possible control modes are displayed, step 744. Then he/she selects the control mode, step 746, and he/she parameterizes the IP address filtering policy, step 748, possibly based on the display of the reported resource uses of the agents of the users or user workstations in question then you go to step 750.

During the step 750, it is determined whether the administrator definitively confirms the security policy parameterized during steps 720 to 748. If not, you go back to step 718. If yes, during a step 752, the security policy is sent to the configuration server(s) and, during a step 754, each agent is configured to comply with the security policy configured by the configuration server(s).

Thus, the utilization of this invention offers a wealth of centralized administration functionalities, enabling the configuration of hundreds of software agents 115 installed on the user workstations 120 of the company's internal network to be automatically deployed from one central administration console or workstation. These distributed Firewall agents offer an economical and effective response to the inherent deficiencies of the traditional Firewalls. This solution offers an unbreakable protection, since it is installed right at the level of the network's workstations 120. It thus allows you to counter all the attacks that might pass through the traditional Firewalls or might evade them (direct modem connections from a workstation, etc) and, of course, those originating from within the network. It does not therefore suffer from the limitations of the prior state of the art described above.

Each time that a user of a workstation 120 identifies him/herself, for example by user name (“login”) and password, said workstation's protection agent 115 transmits this identity to the configuration server, which sends back to it the configuration applicable to both the user workstation in question and the user in question. Thus, the configuration of each protection agent can be dependent on the identity of the user of the user workstation.

It is noted that the agents 115 run as a background task on the user workstations, which is invisible to the users except by means of visual interfaces signaling that access to a resource is prohibited. Furthermore, each protection agent 115 has a means of protection against being deactivated.

The central administration console 100 utilizes a graphical interface, for example object-oriented (written in Java and constructed around a database), enabling large networks to be easily administered. This administration console 100 offers powerful tools for clustering (user groups, configuration groups, etc), importing user definitions from the LDAP and automatically inspecting workstation activities.

It is noted that a solution comprising several configuration servers 105, 110, enables the problems of server breakdowns to be overcome and offers the possibility of a plentiful distribution of download servers, allowing a large number of local or remote sub-networks to be managed in a flexible way (for example, with one configuration server per sub-network).

It is noted that, in other embodiments of this invention, the administration console 100 and the configuration server 105 or 110 can be combined. In addition, when this invention is installed on a personal user workstation, outside a local network, the administration console and the user workstation can be combined and the configuration server can remain remote, or else the administration console and configuration server can be integrated into the Internet service provider's computer systems and managed by the latter on request from the users.

The IP address and service filter module offers an effective internal network access policy, by allowing the list of non-authorized network services and IP addresses to be defined, for each user.

You specify the complete list of the addresses (servers, routers, etc) that a user is not authorized to access, as well as the prohibited services (TCP/UDP ports to be blocked: mail, ftp, etc).

Such filtering makes it possible to limit undesirable accesses and to properly control internal communication flows.

Implementing this invention also offers an original method allowing a workstation's identity to be masked. It thus makes it possible to avoid its identification by hackers.

In order to avoid the control of the agents 115 being overridden by (experienced) users, every measure is offered to prohibit a user from being able to stop or cancel its start-up when the workstation is rebooted (access to the F8 key) under Windows 9X systems, which offer no protection at this level.

In addition, the agent 115 allows the adding of new printers to be blocked. This is so as, for example, to force users to use one single printer (for example, the network printer) and, as a result, to control every document printed. Thus, to block any printing it is just necessary, on certain operating systems, to uninstall the existing printers before activating this option.

The software installed on the administration console 100 offers four centralized monitors:
an audit monitor,
an alert monitor,
a quarantine area monitor and
an automatic network inspection monitor.

The audit monitor allows all the activities of the users on all the network's workstations to be viewed. These activities concern the applications executed, the applications that have accessed the network, and the URL addresses of the sites visited. This monitor is equipped with sorting and filtering mechanisms enabling the administrator an easy and focused examination of the information supplied (tracking the activities of a user, examining refused attempts, etc).

The alert monitor makes it possible to examine, from the administration console, all intrusion attempts made on the network's workstations, and also the Trojan horses detected in these workstations.

Other real-time alert functionalities via e-mail and SMS messages are offered.

The quarantine area management monitor allows the remote management of the quarantining carried out at the level of all the network's workstations. It offers a quarantine manager, which makes it possible to fine-tune the remote examination of Trojan horses or viruses discovered and isolated by the agents. It offers the administrator, after examining them and deciding on their final fate, the possibility of acting remotely, either by deleting suspect programs (files containing a virus or Trojan horse), or possibly by restoring them, if this is considered expedient (non-declared legitimate servers, version updates, etc).

The network inspection monitor allows automatic polling of the network to be carried out and presented graphically to the administrator, in order to detect the existence of fraudulent workstations (probes, etc).

The automatic inspection of the network can be activated at any moment in order to instantly supply the various audit, alert and quarantine monitors and also offer the possibility of automatically collecting the objects required for the configuration of the console, namely the list of network users and the list of applications and URL addresses relating to the activities of the users on the network's workstations 120, which facilitates the definition and updating of these configurations.

In addition, this scan can be carried out simultaneously over several disjoint IP address intervals (sub-networks).

In order to automatically detect agents 115 and then activate them, on the administration console 100 there is a graph tool (network inspection monitor) accessible from a software panel, called “Network Monitor”, on the console screen. This network inspection monitor makes it possible to automatically detect all the workstations installed on the network and view them graphically, indicating those where the agent has been installed and those where it hasn't. In order to enable the inspection of several networks, you can specify the list of several ranges of network addresses to be scanned. To manually launch a scan, you just need to press on a “Refresh” button of the console's graphical interface. This monitor also allows you to specify:
the time-out tolerated during a workstation scan and
the network self-inspection frequency, enabling a real-time inspection of connected workstations and the detection of any probes.

Once the agents 115 are detected by self-inspection, it is just necessary to activate them in order to launch their supervision of the host or user workstation 115 on which they are installed. A non-activated agent 115 is neutral and performs no checks. The network inspection monitor makes it possible to automatically identify and graphically view:
the workstations 120 on which the agent 115 is still not installed (identified by a cross),
the activated agents 115, on the right, and
the agents that are not activated (exclamation mark on the workstation's icon), on the left.

To activate one or more protection agents 115, “activation management” software can be opened by pressing on the “activate agents” button from the network monitor and, in the list of agents 115 detected, it is just necessary to move the agent 115 to the right section by means of the move button (>>). Then “OK”.

Importing from existing LDAP servers is possible and the administration console 100 software makes it possible to check for double definitions of users. In such cases, the administration console 100 notifies it and asks which unique group to include the user in.

To declare authorized local server types in the LAN, a service being defined by the service port used (“Server database” button), when a service is authorized in a user's configuration, any attempt to connect remotely to this port will not be considered an intrusion attempt and will be permitted (definition of legitimate local servers, for example DNS (acronym for “domain name system”), dhcp, http, ftp, Idap, proxy, etc). For example, to declare a web server utilizing the hhtp protocol, the following service can be declared: Port=80, protocol=TCP, Name=http.

The administrator can add a service, characterized by the port, the protocol and also the name(s) of this service, delete a service and modify a service.

The protection system utilizing the process that is the subject of this invention possesses a generic technology enabling any type of Trojan horse to be detected. When an agent detects an attack on a non-legitimate port, this database (“Trojan horse database” tab) is consulted to inform the administrator of the identities of the known Trojan horses that use this port. This database, initially filled with the list of all known Trojan horses, can be expanded as wished by the administrator.

The administrator can add a new Trojan horse definition, characterized by the port, the protocol and also the name(s) of this Trojan horse, delete a Trojan horse and modify the definition of a Trojan horse. For example: to declare the well-known Trojan horse bo2k, the following service can be declared: Port=12345, protocol=TCP, Name=bo2k.

In addition, the administrator can set the size limit for the logs, or traces, so as to avoid filling up the disk space. It is thus possible to specify, at the “administration” panel level, the maximum number of lines of log per user and per log type. Once this maximum size is reached, each new line of log will replace the oldest line.

For example, “1000” means write up to 1000 lines of application log, 1000 lines of URL log, 1000 lines of Trojan horse alerts, etc for each user.

In order to configure the protection system, it is recommended to proceed as follows:

Firstly, prepare the objects needed to define these configurations: lists of users, definition of groups and construction of black/whitelists of the applications and URLs. All these objects can be constructed in an almost automatic way via the functionalities automatically collecting network activities. To this end, and after activating agents, you are recommended to allow the BLR agents the time needed (one or more days) to automatically construct all the lists of users detected on the network as well as the lists of applications and URLs relating to their activities, and to construct them sorted by user.

Once the preparatory step is finalized, you can define/update groups and policies for users, with the protection system's graphical interface, on the console.

To facilitate the configuration of a large number of workstations or user workstations 115, you can define configuration templates on the basis of which the user configurations will be defined, thanks to a concept of inheritance offered by the protection system. When defining a configuration for a user (or group of users), you can start with this existing template.

Implementing this invention allows a default configuration to be defined relating to “guest” users. This latter serves as the configuration for any user who is not defined in the users database or who has not been assigned a specific configuration. This configuration generally comprises the minimum possible rights and permissions.

All the components of the control agents 115 (application, network and URLs) adopt the same principle of configuration by levels. Four configuration levels are proposed:
“High” level of control (Whitelist): only the applications (or URLs) contained in this module's whitelist will be authorized, all the others will be refused (strict and high control allowing only a predefined set of applications or URLs);
“Medium” level of control (Blacklist): only the applications (or URLs) contained in this module's blacklist will be blocked, all the others will be authorized;
control deactivated (“All authorized” mode): completely deactivates a control module and
“Block everything” mode: access is completely blocked for all the applications that will be launched (or URLs).

The following configuration parameters are also proposed:

Mask the identification of the workstations 115: this function allows the workstation's identification (Netbios) to be modified, by generating a random name for the computer on each reboot, so as to make it difficult to identify a workstation on the network. Allied to a dynamic management of addresses (DHCP), this makes identifying a workstation almost impossible.

To this end, the process that is the subject of the present invention utilizes a step of automatically modifying a computer network's user workstation name and/or user workstation address, the matching of the modified name and/or address with the user workstation's actual name and/or address only being known from an administrative workstation linked to said network, for example the console 100 or the server 105 or 110.

Blocking access to the network when the workstation 115 is idle: when the machine is idle (standby screen) it is probable that Trojan horses are automatically launched to access the network. Implementing this invention enables new network accesses to be blocked when the machine 115 is idle. Moreover, it does not block machines that had already accessed the network during the user's activity (launching an FTP, etc) unless otherwise specified.

With regard to protection against the replication of unknown viruses: the process that is the subject of this invention offers a generic mechanism, which strengthens the traditional anti-viruses, allowing protection against the replication of malicious codes (viruses, worms, etc), especially those not listed and therefore undetectable by traditional anti-viruses (ant-virus not updated or any new virus). It thus makes it possible to detect the slightest modification of the executable files listed in its execution database and to destroy them and put them in quarantine. Implementing this invention also allows this control to be deactivated temporarily (version updates, etc).

The quarantine monitor 255 manages the quarantine area, which contains the list of applications quarantined (isolated) by the protection agents 255 following detection of a virus or Trojan horse. This monitor 255 groups the applications quarantined together by workstation and displays them in a table supporting sorting and filtering. Each line of the table represents an isolated application and the user during the session in which the detection occurred.

Collecting the list of application put into quarantine is carried out at the request of the administrator, as follows:—press the quarantine monitor's “REFRESH ALL” button and a dialog box for selecting agents will appear.—Select the workstations to be inspected or press “SELECT ALL” to include all the network's workstations.—press “Items” and check the “quarantine” box.—Activate the collection (refresh) by operating the “REFRESH” button.

The administrator has three possible actions for applications put into quarantine, where these actions can be remotely commanded on any application quarantined by the protection agents 115. By right-clicking the mouse on the line of the quarantined program, a pop-up menu is displayed, giving the choice between:
restore: this involves restoring the application from the quarantine area to its original location. This case involves a bad parameterization of the implementation of this invention:
   Non-declaration of a local server, whose basic behavior had been suspected to be that of a Trojan horse by the agent or
   the updating of versions of executable files, without having configured the agent to allow signatures to be updated.
destroy: this involves completely destroying the application from the disk of the workstation where the quarantining had been carried out.
destroy directory: this involves completely destroying the application and also the directory in which this application has been illegally installed, in order to block the way for any other infected sub-programs. This option is to be operated with care, so as not to destroy legitimate directories.

Thanks to context-sensitive buttons, the administrator can:
refresh the list of items quarantined by agents,
erase the content of the quarantine monitor and
print the content of the area.

The “Network Monitor” of the administration console 100 enables the networks to be scanned and graphically depicted, in order to easily discover illicit workstations (probes, laptops, etc).

The administrator can specify several ranges of network addresses to be inspected. To do this, he/she just has to declare these ranges in the “network monitor”, under the “List of ranges” button. A range of addresses is defined by the addresses at the start and end of the range, and several of them can be defined, if you want to scan several networks or network packets. Initially, the network range in which the console is installed is added automatically. Other ranges can be declared, as follows:
adding a range: the “add” button allows a new address range to be added, By pressing this button, the next window allows the start and end address of the network inspection to be entered;
modifying an existing range: the “modify” button allows an existing range of addresses to be modified. By pressing this button the previous window is opened, allowing the start and end addresses to be modified, and
deleting a range; if you want to exclude an existing range from the inspection operation, you can simply delete it via the “delete” button.

Once your ranges of addresses are declared, you can manually launch a self-inspection by pressing the “refresh” button. A progress bar is displayed and indicates the progress of the operation, which ends by displaying all the workstations detected and indicating the presence or absence of protection by the protection agents. The “cancel” button allows the inspection in progress to be cancelled before it finishes.

If the network comprises several ranges of addresses, the administrator can limit the inspection to a single network range, by selecting only the range wanted and launching the self-inspection. It is noted that the “all ranges” root node allows an inspection to be launched for all the ranges.

The graph makes it possible to view the workstations detected in the selected range of addresses. In this graph each node is represented by a workstation icon. There are three types of icons:
crossed-out workstation icon: this relates to a workstation on which the protection agent is not installed and thus it may relate to a spy workstation (probe, laptop, etc), and also it may relate to a network peripheral or a workstation 120, booting, i.e. starting, under a system other than Windows.
normal icon: this relates to a workstation protected by an activated protection agent.
workstation icon with an exclamation mark: this relates to a workstation containing a protection agent not yet activated.

The console's “network monitor” makes it possible to view the status of the connections and the ports open on the network's workstations. You just need to select the icon of the workstation wanted and click (fight-button) in order to see a sub-menu displayed, allowing the “Open Ports” option to be selected. The result is displayed in a separate sub-window, according to the standard format of the Netstat network command.

So that the different information supplied by the administration console 100 is used and examined as easily as possible by the administrator, the implementation of this invention offers, at the level of all the tables, monitors, sort and filter possibilities and also embedded filters and sorts.

It is noted that, for mobile user workstations 120, which connect to and disconnect from the company network, the agent 115 permanently maintains compliance with the company's security policy. When the mobile user workstation 120 connects to the Internet, the agent 115 connects to the server 105 or 110. In variants, the agent 115 takes into account the context, i.e. the absence of the mobile workstation 115 from the company's network, to modify its operation, for example by making the security rules applied tougher, for example so as to prohibit the copying of protected resources onto removable information media or access to the company's resources or switching from an operation using a blacklist to one using a whitelist, for example.

FIG. 8 represents, in the form of a logical diagram, a particular embodiment of the process that is the subject of the present invention.

During a step 805, the resources to be protected, for example files, folders or directories, are defined.

During a step 810, the applications that are authorized to interact with the data to be protected are defined. For example, for resources to be protected that are in text or document format, only a word-processor is authorized to open or edit these data.

During a step 815, a certificate of integrity is associated to each executable file of the applications selected during the step 810 and to each resource protected. For example, a certificate of integrity is constituted derived from a hashing function, possibly truncated, known as the “hash” or digest of the executable file.

During a step 820 are constituted a correlation table for each resource and each application or executable file authorized to access said resource, a correlation table for the protected resources and their certificates of integrity and a correlation table for the applications or executable files and their certificates of integrity, it being understood that a resource, application or executable file may be associated to several certificates of integrity, depending on the number of independent components that they comprise or utilize.

The set of steps 805 to 820 can be carried out by the console 100 and/or by an agent 115 present on the user workstation 120 in question. In particular, the steps 815 and 820 are for preference carried out by an agent 115 present on the user workstation 120.

During a step 825, it is determined whether an access to a resource is requested. For example, an access to a resource is requested when you select, with a pointing device, for example a mouse, an icon or a resource name associated to a resource to be protected, in order to open the resource or to perform an action on it (for example copy it, cut it, change its name) or when an application tries to access the resource, for example to open the file. In a variant, the determination that an access request has been made waits until an action is requested on a resource, for example a copy or cut attempt, or an open attempt.

If the result of step 825 is negative, you go back to step 825 and the user workstation operates, under the control of the agent 115, in accordance with the security policy that concerns it.

If the result of step 825 is positive, during a step 830, the user workstation's external ports are closed, in particular the communication ports on a computer resource and, for preference, the removable data media communication ports. For preference, during the step 830, all the user workstation's external ports are closed, possibly except for the port used by the agent 115 to communicate with the security server 105 or 110.

Then, during a step 835, it is determined if the access to the resource, by the computer entity that made the request, is authorized, by utilizing the correlation table associating to the resource in question the applications and executable files authorized to access it.

If the result of step 835 is negative, during a step 840 a message is displayed on the user workstation, a trace of the incident is stored in a log intended for traceability and, possibly at a later time, this incident is communicated to the security server 105 or 110. Then, you go back to step 825.

If the result of the step 835 is positive, during a step 845, the certificates of integrity of the resource and the computer entity attempting to access it are verified. If the verification is negative, step 840 is performed. If the result of the verification is positive, during a step 850, access to the resource by the computer entity making the request is authorized.

Then, during a step 855, it is determined if the use of an external communication port is requested. If not, you go back to step 855. If yes, during a step 860, all the protected resources are backed up, possibly asking the user if he/she wants to keep the resource modifications carried out since the last back-up, each protected resource is closed and a certificate of integrity is assigned to each protected resource. Then, during a step 865, it is determined, in accordance with the security policy, if the opening of the port requested is authorized and, depending on whether authorized, or not, the port in question is opened, or not.

Then you go back to step 825.

By implementing the process detailed with regard to FIG. 8, a trusted perimeter is put in place that is variable or switchable between at least two states, a first state in which the protected resources cannot be accessed but the external communication ports can be and a second state in which the protected resources can be accessed by authorized applications and executable files but all the external communication ports are closed in case of access to one of the protected resources.

So that the user can transmit data constituting protected resources, a sandbox is put in place serving as input or output buffer memory area and the files are scanned in this buffer memory, i.e. they are analyzed to determine whether they contain malicious software, according to known techniques.

To this end, in order to transmit a protected resource, there is provided a step copying or transferring from a protected resource in a buffer memory area, the user workstation's external ports therefore being closed and the resource in said memory area therefore being not protected, and a step of remote transmission from said non-protected resource, via said buffer area, by means of a said external port.

In the case of the reception of a resource, by means of an external port, this resource is placed in an input buffer memory area, and in the case in which, during a selection step 805, said resource is selected to be protected, the agent 115 performs a step of processing said resource to determine whether it contains malicious software, the user workstation's external ports then being closed.

In a variant, in the case of a request to access a protected resource, a user identification verification step is carried out and, in the case where the user is not identified, no application can access the protected resources.

In a variant, instead of steps 805 and 810, there is provided a step of determining or selecting, for each executable file or application present on the user workstation, resources that said executable file or application can access, known as “authorized resources”, and, in the case where the executable file or application attempts to access a resource other that the authorized resources, a step of blocking said attempt.

FIG. 9 represents, in the form of a logical diagram, steps utilized to implement a particular embodiment of an aspect of the process for protecting computer systems that is the subject of this invention. For preference, these steps are utilized by the console 100.

During a step 905, at least one user workstation 120 is selected. During a step 910, the incorporation, by software means, of each user workstation 120 selected into a group of user workstations is ordered. In this group of user workstations, the user workstations possess, between them, broader access rights than the access rights assigned to user workstations outside said group. Thus, it is no longer necessary to modify hardware switches in order to create and modify groups of workstations making up a trusted network. To perform this incorporation, during a step 910, the operation takes place on the second layer of the representation in OSI layers. Thus action takes place at a level below or equal to that of a firewall and below layers utilized by the TCP (acronym for “transmission control protocol”), which are layers 3 and 4.

During step 910, a MAC (acronym for “media access control”) address of the user workstation incorporated into the group is sent to every other user workstation of said group.

From step 910, the agent 115 located on each user workstation 120 of the group of user workstations 120, authorizes or prohibits access to, at least, one part of its resources, according to the MAC address transmitted by a user workstation that attempts to access one of said resources, step 915, checking that its MAC address corresponds to a MAC address transmitted during step 910, step 920. Thus, the resources available on the user workstation 120 are isolated, these resources remaining accessible to the members of the trusted group thus created and not available to the user workstations 120 that are not in this trusted group.

During a step 925, an additional selection of user workstations is performed, from among the user workstations 120 of a said group of user workstations 120. From step 925, a sub-group of the group of user workstations is constituted, step 930 and each agent 115 of a selected user workstation 120 is ordered to perform an additional sort of the third-parties attempting to access at least one part of its resources depending on its presence in said sub-group. According to particular features, the software agent 115 of each user workstation 120 selected during the step 925 determines, on a layer higher than the second OSI layer, if a user workstation that attempts to access a resource is authorized to do so, step 935.

From step 925, the agent 115 of a user workstation 120 selected during the step 925 authorizes access to a part of its resources, by a workstation selected during the step 925, said resources not being accessible to user workstations 120 of said group of user workstations 120 that were not selected during the step 925. By iteration, a tree structure is created of groups of user workstations given access rights to resources of other user workstations located on the same branch of the tree structure, hierarchically arranged, with respect to user workstations located on other branches.

The person in charge of a computer network can thus create a hierarchized virtual local area network with the user workstations.

FIG. 10 represents, in the form of a logical diagram, steps implementing a particular embodiment of an aspect of the process for protecting computer systems that is the subject of the present invention.

During a step 1005, from the console 100, a certificate containing a private key of a signature key pair complying with the PKI (acronym for “public key infrastructure”) is assigned and distributed to each agent 115 of a user workstation 120 on the company's network.

During a step 1010, each agent 115 of a user workstation 120 is sent a list, from the security server 105 or 110, of the MAC addresses of the user workstations authorized to communicate with it, together with the public keys of these user workstations, which correspond to the private keys distributed during the step 1005.

During a step 1015, the agent 115 of a first user workstation that wishes to enter into communication with a second user workstation performs the signature and/or encryption, with its private key or with the second user workstation's public key respectively, of at least the first user workstation's MAC address and, possibly, the second user workstation's MAC address.

During a step 1020, the first user workstation sends a request to open communication to the second user workstation adding, in the header of the first data packet representing said request a sequence of symbols representing the result of the processing carried out during the step 1015.

During a step 1025, the data packets transmitted by the first user workstation are placed in the second user workstation's mailslot 320.

During a step 1030, the second user workstation's executable file “agent.exe” reads only the header of the first data packet transmitted by the first user workstation, header comprising the sequence of symbols.

During a step 1035, the second user workstation's executable file performs the inverse of the processing performed during step 1015, to obtain, at least, the MAC address of the first user workstation.

During a step 1040, the second user workstation's executable file “agent.exe” determines whether the MAC address transmitted by the first user workstation forms part of the MAC addresses of user workstations authorized to communicate with the second user workstation. If not, the second user workstation destroys the data received from the first user workstation, step 1045. If yes, the second user workstation opens communication with the first user workstation, i.e. opens an external communication port dedicated to this communication, step 1050. After either of steps 1045 or 1050, you go back to step 1020.

Thus, the second user workstation only opens the communication port if it identifies that the first user workstation is authorized to communicate with it. Furthermore, a malicious third-party who does not have the encryption key, or the signature key or signature and/or encryption data cannot generate a sequence of symbols allowing it to obtain a port opening on the second user workstation.

It is noted that the sequence of symbols transmitted during the step 1020 can also represent a simple password transmitted beforehand, by the console 100 to each user workstation, and this password can be different for all the pairs of first and second user workstations. The symbol sequence can also not be signed or not be encrypted.

It is noted that the sequence of symbols can also not be located in the header of a data packet or not be in the first data packet transmitted by the first user workstation.

For preference, the step adding the sequence of symbols 1020 and the port opening authorization step 1040 are performed at least for the requests made by the first user workstation to access one of the second user workstation's resources.

For preference, the step adding the sequence of symbols 1020 and the port opening authorization step 1040 are performed at the start of each communication between said first and second user workstations and, similarly, by all the computer system's user workstations for all their communications.

In variants, the port that the first user workstation asks to be opened is represented by the sequence of symbols.

In a variant, and for preference, when the user workstation switches to standby, the agent 115 causes the closure of all the external communication ports, except for that reserved for it. In the event of a communication attempt on this reserved port, as described with respect to FIG. 10, the agent 115 processes the incoming communication requests in order to determine whether a port opening is authorized in order to implement a direct communication not passing via the software agent 115 or via the communication over said port by the intermediary of said software agent.

1-12. (canceled)

13. A process for protecting data and computer systems, that comprises:
a step of installing at least one software agent on at least one user workstation,
a step of capturing, by said agent, information representative of effective uses of resources on said user workstation,
a step of transmitting remotely, by said agent, information representative of said effective uses of resources on said user workstation,
a step of selecting, remotely from the user workstation, authorized resources and/or prohibited resources on at least one user workstation and
a step of transmitting to said workstation information representative of said authorized resources and/or said prohibited resources and
on said workstation, a step of inhibiting, by said agent, the use of prohibited or non-authorized resources.

14. A process according to claim 13, that further comprises:
a step of processing, remotely, said information representative of effective uses of resources originating from at least one said agent, in order to provide aggregate use data,
the selection step utilizing said aggregate use data.

15. A process according to claim 13, that further comprises:
a step of transmitting, from at least one user workstation on which a software agent has been installed to a console remote from said user workstation, said information representative of effective uses of resources on said user workstation and
a step of transmitting, from said console to a server, information representative of said authorized resources and/or said prohibited resources,
the step of selecting authorized resources and/or prohibited resources on at least one user workstation being performed on said console.

16. A process according to claim 13, wherein said resources comprise access to remote sites over a worldwide computer network, the inhibition step comprising a step filtering the electronic address of each page that the user workstation tries to access, by recognizing a predefined part of this address, filtering hypertext links present in each page that said user workstation accesses and/or filtering each page that the user workstation tries to access by recognizing a predefined sequence of symbols in a description of said page.

17. A process according to claim 13, wherein said resources comprise access to computer applications, the inhibition step comprising a step recognizing computer applications that the user workstation tries to access.

18. A process according to claim 13, wherein said resources comprise access to computer resources via local computer applications, the inhibition step comprising a step recognizing a computer resource that an application of said user workstation tries to access.

19. A process according to claim 13, that further comprises a step determining the profile of at least one user workstation on which a software agent is installed, the selection step utilizing said profile in such a way that two identical workstation profiles are assigned the same resource use prohibitions.

20. A process according to claim 13, that further comprises a step determining the profile of at least one user of a user workstation on which a software agent is installed, the selection step utilizing said profile in such a way that two identical user profiles are assigned the same resource use prohibitions, the inhibition step utilizing an identification of the user of the user workstation in question.

21. A process according to claim 13, wherein said resources comprise the modification of a software executable file, the inhibition step comprising a step verifying the integrity of the executable file.

22. A process according to claim 13, wherein said resources comprise the modification of the user workstation's system parameters, the inhibition step comprising a step recognizing attempts to access the system parameters of said user workstation.

23. A process according to claim 13, wherein said resources comprise the use of hardware resources for storage on removable media or printing of data, the inhibition step comprising a step recognizing the destination hardware for a transmission of information.

24. A device for protecting data and computer systems, that comprises:
at least one user workstation on which a software agent is installed, said agent being adapted to capture information representative of effective uses of resources on said user workstation and to inhibit the use of prohibited resources,
a step of processing said information representative of effective uses of resources originating from at least one said agent to provide aggregate use data,
a means of displaying said aggregate use data,
a means of selecting prohibited resources on at least one user workstation.
